(19) United States
(12) Patent Application Publication
(10) Pub. No.: US 2015/0371444 A1
(43) Pub. Date: Dec. 24, 2015

(54) IMAGE PROCESSING SYSTEM AND CONTROL METHOD FOR THE SAME

(71) Applicant: CANON KABUSHIKI KAISHA, Tokyo (JP)

(72) Inventors: Kazutoshi Hara, Kawasaki-shi (JP); Hiroichi Yamaguchi, Sagamihara-shi (JP); Kazuki Takemoto, Kawasaki-shi (JP)

(21) Appl. No.: 14/730,667

(22) Filed: Jun. 4, 2015

(30) Foreign Application Priority Data
Jun. 18, 2014 (JP) 2014-125757

(51) Int. Cl. G06T 19/00; G01B 11/14; G06F 9/54; G02B 27/01

(52) U.S. Cl. CPC G06T 19/006; G02B 27/0172; G01B 11/14; G06F 9/542

(57) ABSTRACT

An image processing system includes an image processing apparatus that is wearable by a user and is configured to capture real space and display real space video. The system generates mixed reality video obtained by superimposing virtual object video on the real space video; identifies a display area of a real object that is included in the real space video; measures a distance between the image processing apparatus and the real object. In addition, the system performs notification for causing a user who is wearing the image processing apparatus to recognize existence of the real object, if the display area of the real object is hidden by the virtual object video, and the distance between the image processing apparatus and the real object is less than a predetermined distance.

### BACKGROUND OF THE INVENTION

1. Field of the Invention

The present invention relates to an image processing technology in a mixed reality system.

2. Description of the Related Art

In recent years, use of mixed reality (MR) systems that seamlessly merge the real world and virtual space in real time has become more prevalent. One method of realizing a MR system is a video see-through type system. In a video see-through type system, a camera that is attached to a head mounted display (HMD) is used to capture a field-of-view area of a HMD user. An image obtained by superimposing computer graphics (CG) on the captured image is then displayed on a display that is attached to the HMD, allowing the HMD user to observe the displayed image (e.g., Japanese Patent Laid-Open No. 2006-301924).

In order to enhance the sense of mixed reality, such a MR apparatus needs to acquire the viewpoint position and orientation of the user of the apparatus in real time and display an image on a display apparatus such as a HMD in real time. In view of this, the MR apparatus sets the viewpoint position and orientation in the virtual world based on the user's viewpoint position and orientation measured by a sensor, renders an image of the virtual world by CG based on this setting, and combines this rendered image with an image of the real world.

However, in the MR apparatus, the field of view of the real world that overlaps the area in which CG is rendered will be blocked. Thus, the user experiencing the mixed reality using the HMD is not able to perceive objects in the field of view of the real world corresponding to the area in which CG is rendered. That is, even if an object that approaches the user exists in the field of view of the real world corresponding to the area in which CG is rendered, the user will be unable to recognize that he or she could possibly contact the object.

### SUMMARY OF THE INVENTION

According to one aspect of the present invention, an image processing system including an image processing apparatus that is wearable by a user and is configured to capture real space and display real space video, the system comprises: a generation unit configured to generate mixed reality video obtained by superimposing virtual object video on the real space video; an identification unit configured to identify a display area of a real object that is included in the real space video; a measurement unit configured to measure a distance between the image processing apparatus and the real object; and a notification unit configured to perform notification for causing a user who is wearing the image processing apparatus to recognize existence of the real object, if the display area of the real object is hidden by the virtual object video, and the distance between the image processing apparatus and the real object is less than a predetermined distance.

According to the present invention, a technology that enables a user experiencing a sense of mixed reality to perceive the possibility of contacting an object that exists in the real world can be provided.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing usage of a HMD according to a first embodiment and examples of MR display.

FIG. 2 is a flowchart illustrating operations of a HMD 100.

FIG. 3 is a diagram showing an internal configuration of the HMD 100.

FIG. 4 is a diagram showing an overall configuration of a MR system according to a second embodiment.

FIG. 5 is a diagram showing an internal configuration of a HMD 400.

FIG. 6 is a diagram showing an internal configuration of a PC 402.

FIG. 7 is a diagram showing an internal configuration of a camera 404.

FIG. 8 is a flowchart illustrating operations of the PC 402.

FIG. 9 is a diagram showing an overall configuration of a MR system according to a third embodiment.

FIG. 10 is a flowchart illustrating operations of a HMD 900.

FIG. 11 is a flowchart illustrating operations of a PC 902.

FIG. 12 is a diagram showing an internal configuration of the HMD 900.

FIG. 13 is a flowchart illustrating processing for hazard avoidance according to an approaching velocity of a real object.

### DESCRIPTION OF THE EMBODIMENTS

Hereinafter, preferred embodiments of the invention will be described in detail, with reference to the drawings. Note that the following embodiments are merely examples, and are not intended to limit the scope of the present invention.

### First Embodiment

A first embodiment of an image processing apparatus according to the present invention will be described below, giving a video see-through type head mounted display (HMD) that displays mixed reality (MR) as an example.

Device Configuration

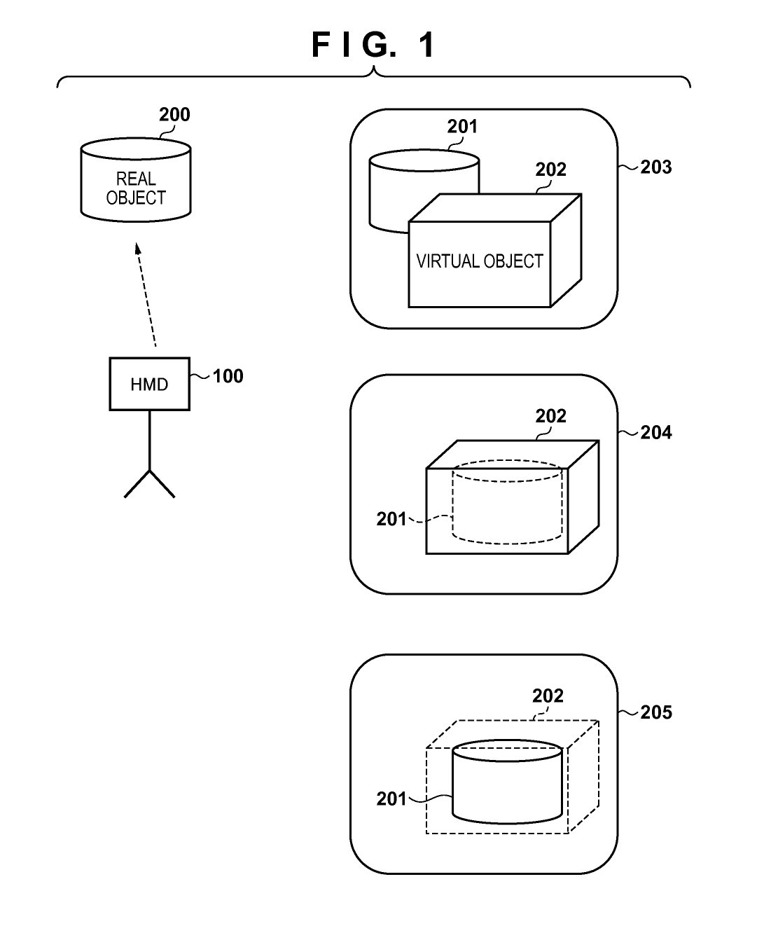

FIG. 1 is a diagram showing usage of a HMD 100 according to the first embodiment, and examples of MR display. As described above, the HMD 100 is configured as a video see-through type HMD, that is, a type of HMD that displays mixed reality video obtained by superimposing video of an object existing in a virtual world on video of the real world (real space video) captured by an image sensing unit on a display unit. As shown in FIG. 1, in the following description, a situation where a user who is wearing the HMD 100 on his or her head is looking in the direction of a real object 200 that exists in the real world will be described. Note that real objects are arbitrary objects, and include buildings, vehicles, and people.

The real object 200 appears on screens 203 to 205 of the display unit of the HMD 100 as shown by a display 201. That is, the display 201 is partially or entirely hidden, depending on the display position of a display 202 of a virtual object that is rendered by CG.

If a portion of the real object 200 is visible, as in the screen 203, an observer (user) can avoid a collision even in the case where the real object 200 approaches. In this case, a loss of the sense of mixed reality is prevented by keeping the display 202 of the virtual object unchanged.

Here, the case where the display position of the display 202 of the virtual object is determined independently of the position of the real object 200 is assumed. In this case, if the real object 200 moves, the display 201 of the real object 200 may be completely hidden behind the display 202 of the virtual object and no longer be visible, as shown on the screen 204. In this state, when the real object 200 approaches in the direction of the HMD 100, the real object 200 will suddenly jump out in front of the display 202 of the virtual object at some point. That is, the observer wearing the HMD 100 will not be able to perceive the existence of the real object 200 until the real object 200 moves in front of the display 202 of the virtual object, and there is a danger of colliding with or contacting the real object 200 in real space.

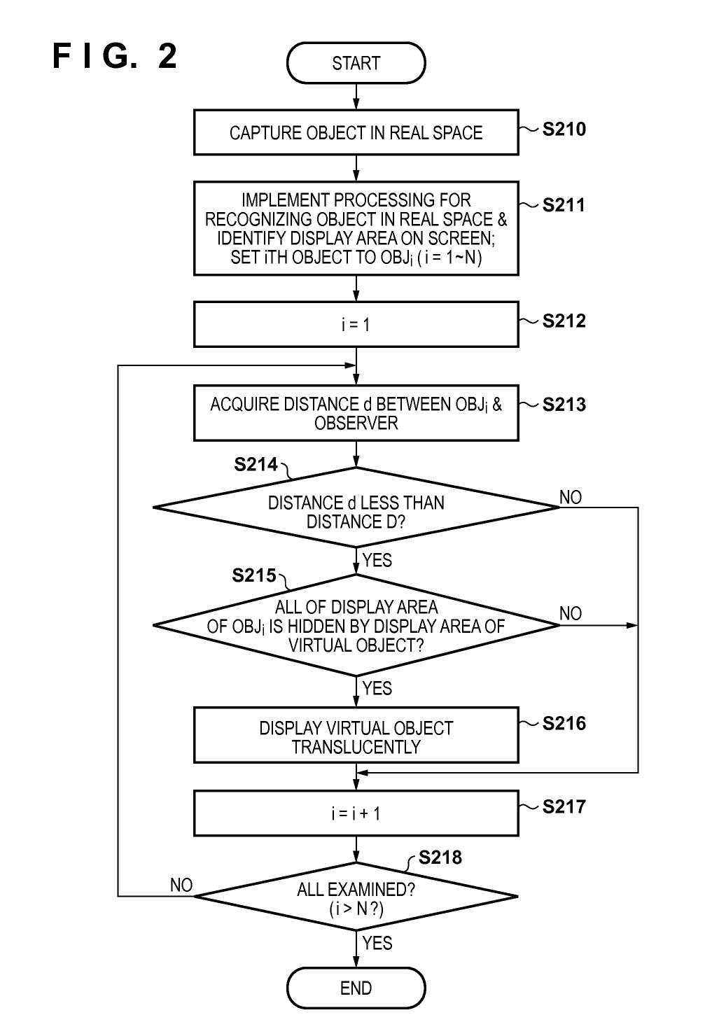

In view of this, in the first embodiment, control is performed so as to enable the observer to perceive the real object 200, in the case where the real object 200 approaches to within a predetermined distance while remaining hidden by the display 202 of the virtual object. Specifically, as shown on the screen 205, control is performed to display the display 202 of the virtual object only as a contour or to display the display 202 of the virtual object translucently. Also, control is additionally performed to display warnings and to sound warning tones. These controls will be discussed in detail later with reference to FIG. 2.

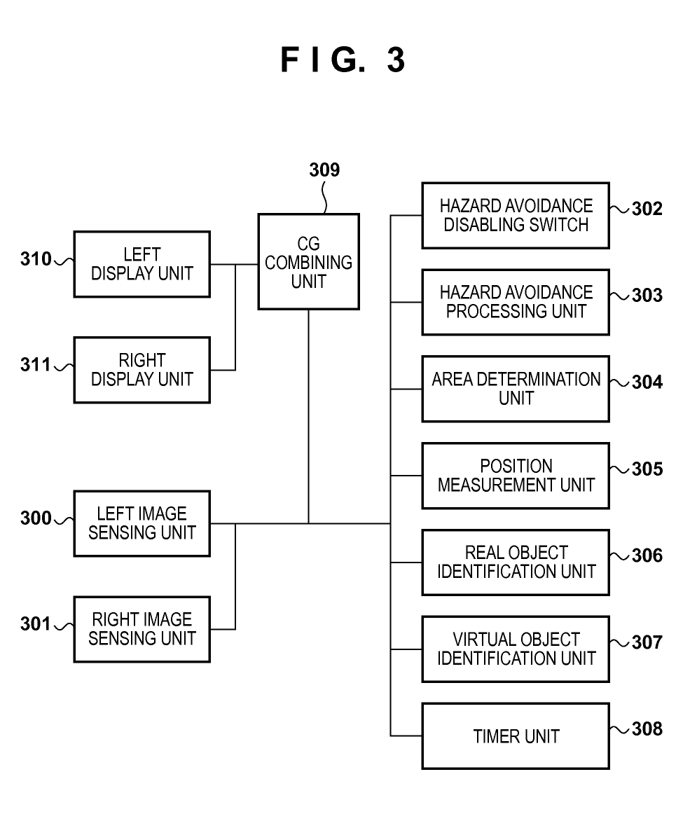

FIG. 3 is a diagram showing an internal configuration of the HMD 100. A left image sensing unit 300 (image sensing unit for left eye) and a right image sensing unit 301 (image sensing unit for right eye) are respectively functional units that capture real space based on the viewpoint position and direction of the observer. A CG combining unit 309 is a functional unit that generates CG of objects in virtual space, and generates video that combines (superimposes) the CG with the respective video captured by the left image sensing unit 300 and the right image sensing unit 301. A left display unit 310 and a right display unit 311 are functional units that display video that is to be respectively displayed to the left eye and the right eye of the observer.

A hazard avoidance disabling switch 302 is a switch for disabling the hazard avoidance processing discussed later with reference to FIG. 2. A hazard avoidance processing unit 303 is a functional unit for performing processing to display the display 202 of the virtual object only as a contour or to display the display 202 of the virtual object translucently.

An area determination unit 304 is a functional unit that determines whether the display area corresponding to each object existing in real space is hidden by the display area of a virtual object. A position measurement unit 305 is a functional unit that measures the distance between a real object and the observer. A real object identification unit 306 is a functional unit that identifies where real objects captured with the image sensing unit are displayed on a screen that is displayed on the display unit. A virtual object identification unit 307 is a functional unit that identifies where virtual objects are displayed on a screen that is displayed on the display unit. A timer unit 308 is a functional unit for realizing a clocking function.

Note that although the HMD 100 includes a plurality of functional units as described above, not all of these functional units need be installed in the HMD 100. For example, the CG combining unit 309 may be configured to be realized by a personal computer (hereinafter, PC) which is an external device. In this case, the HMD 100 and the PC are connected via a cable or through wireless communication so as to enable the HMD 100 and the PC to communicate with each other. An IEEE 802.11 wireless LAN, for example, can be used for wireless communication. Also, the HMD 100 is provided with a hardware configuration including at least one CPU and various memories (ROM, RAM, etc.) which are not illustrated. The respective functional units 302 to 309 described above may be provided by hardware or may be provided by software. In the case where some or all of these functional units are provided by software, the respective functions are executed by the CPU provided in the HMD 100 executing software equivalent to each functional unit.

Device Operations

FIG. 2 is a flowchart illustrating operations of the HMD 100. This flowchart is started by the HMD 100 being powered on and real objects being captured in S210 with the left image sensing unit 300 and the right image sensing unit 301. The steps shown in FIG. 2 are processed by the CPU provided in the HMD 100 executing a program stored in memory.

In S211, the real object identification unit 306 identifies where the real objects that appear on each image sensing unit are displayed on the screen. This involves identifying areas forming one consolidated area from a captured image, and the technique used may be 4-neighbor labeling, for example. The area occupied by an ith object associated by the labeling is set to OBJᵢ (i=1 to N). N is the total number of identified areas. Also, a method that involves identifying an area from three-dimensional edges that are produced using parallax information of the right and left images obtained from the left image sensing unit 300 and the right image sensing unit 301 may be used as the labeling processing that is performed at this time. Other methods of identifying and labeling areas have been variously proposed, and any technique may be used.

In S212, the HMD 100 initializes the variable i to 1. That is, the following processing of S213 to S216 is performed for each object recognized at S211.

In S213, the position measurement unit 305 measures the distance between the real object corresponding to OBJᵢ and the observer and sets the obtained distance as d. Here, a method using a depth sensor is used as the measurement method. Any method that is able to measure distance can, however, be used. For example, a method of computing the distance between the observer and the real object that is represented by OBJᵢ using parallax information of the right and left images obtained from the left image sensing unit 300 and the right image sensing unit 301 may be used. Also, a method of measuring distance using an external camera may also be used. Furthermore, a technique called PTAM (Parallel Tracking and Mapping) that reconstructs three-dimensional space from image information that changes temporally may be used.

In S214, the HMD 100 determines whether the distance d is less than a distance D that is set in advance as presenting a danger of contact. If the distance d is not less than the preset distance D, the processing advances to S217, and if the distance d is less than the distance D, the processing advances to S215.

In S215, the virtual object identification unit 307 identifies areas where virtual objects are rendered on the screen. Then, the area determination unit 304 determines whether all of the display area corresponding to OBJᵢ is hidden by some of the areas (here, these areas are given as CGᵢ (i=1 to M)) identified by the virtual object identification unit 307. Whether the area that is represented by OBJᵢ is hidden is determined by whether CGᵢ (i=1 to M) is disposed on the pixel coordinates of the area represented by OBJᵢ.

Note that “some” here expresses the fact that the display area corresponding to OBJᵢ may also be hidden by display areas corresponding to a plurality of virtual objects rather than only the display area corresponding to one virtual object. If all of the area corresponding to OBJᵢ is hidden, the processing advances to S216, and if a portion of the area corresponding to OBJᵢ is not hidden, the processing advances to S217. Note that a configuration may be adopted in which it is determined whether a predetermined percentage (e.g., 90%) rather than “all” of the display area of OBJᵢ is hidden.

In S216, the hazard avoidance processing unit 303 performs hazard avoidance processing. The hazard avoidance processing is here assumed to involve displaying CGᵢ (i=1 to M) obtained in S215 translucently. As a result of this processing, an observer is able to perceive beforehand that a real object exists and is able to avoid colliding with the real object. Note that the hazard avoidance processing may also be configured to display CGᵢ (i=1 to M) as a contour (wire frame display), for example. Also, additionally, a warning may be displayed or a warning tone may be sounded.

In S217, the HMD 100 increments the variable i, and, in S218, the HMD 100 determines whether all of OBJᵢ have been examined. The processing is ended if examination of all of the areas OBJᵢ is completed. If there is still an OBJᵢ that has not been examined, the processing advances to S213.

Incidentally, the processing of the flowchart in FIG. 2 will result in some form of hazard avoidance processing being performed in the case where a real object exists within the distance D, even when there is no danger of colliding with the real object. As a result, the sense of mixed reality may be lost. In view of this, it is preferable to provide the hazard avoidance disabling switch 302 in the HMD 100. In the case where the hazard avoidance processing has been set to disabled by the hazard avoidance disabling switch 302, the hazard avoidance processing unit 303 inhibits execution of the hazard avoidance processing. Note that this switch may be provided in the HMD 100 or may be provided externally. Also, the observer may operate this switch, or an operator who is observing the situation from outside may perform processing.

Also, the hazard avoidance processing unit 303 may be configured to disable the hazard avoidance processing automatically in the case where a given time period has elapsed from when the hazard avoidance processing occurred, using clocking information provided by the timer unit 308.

Incidentally, while execution of the hazard avoidance processing is controlled according to the distance d in the abovementioned S214, the hazard avoidance processing of S216 may be performed according to the velocity at which a real object represented by OBJᵢ approaches the observer. In other words, control is performed according to velocity, since there is little danger of a collision when a real object approaches the observer slowly.

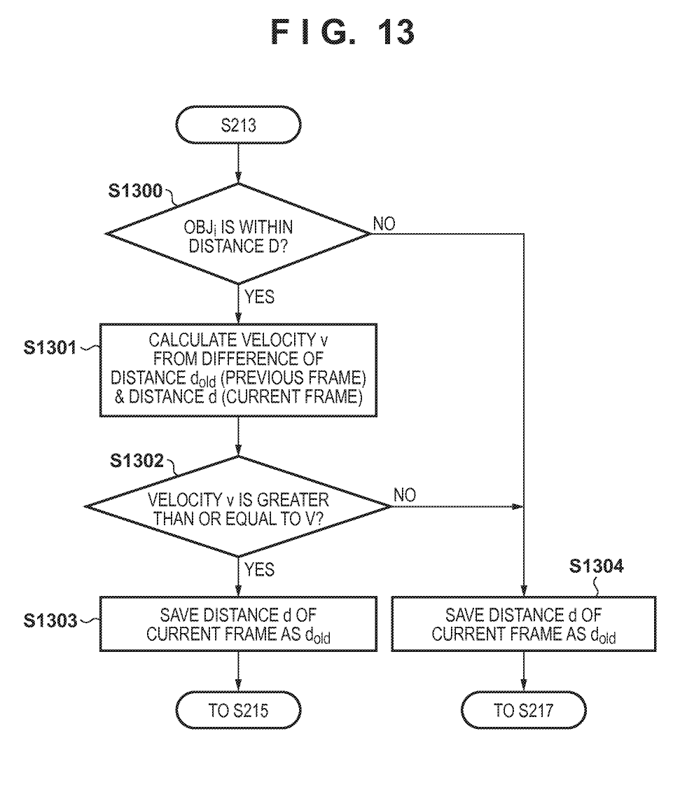

FIG. 13 is a flowchart illustrating operations for performing hazard avoidance processing according to the velocity at which a real object approaches the observer. This flowchart is executed by the CPU of the HMD 100 instead of S214 in FIG. 2.

In S1300, the HMD 100 determines whether the distance d is less than the distance D that is preset as presenting a danger of contact. If the distance d is not less than the distance D, the processing advances to S1304, and if the distance d is less than the distance D, the processing advances to S1301.

In S1301, the HMD 100 calculates a velocity v at which the real object is approaching the observer based on the difference of a distance d_{old} between the OBJᵢ and the observer in the previous frame and the distance d in the current frame. That is, the relative velocity is determined based on the temporal change in distance (velocity determination unit). Note that the distance d_{old} is saved for every frame in S1303 and S1304.

In S1302, the HMD 100 determines whether the velocity v is greater than or equal to a predetermined velocity. If the velocity v is greater than or equal to the predetermined velocity V, the processing advances to S1303, and if the velocity v is less than the predetermined velocity V, the processing advances to S1304. Note that the predetermined velocity V referred to here may be a fixed value, or may be a value that is set to decrease with distance.

According to the first embodiment as described above, hazard avoidance processing is executed in the case where a real object that is hidden by a virtual object exists, and the distance d to the real object is less than a predetermined distance D. Specifically, hazard avoidance processing simply involves displaying a virtual object translucently or as a contour. As a result of this processing, a HMD user (observer) can perceive beforehand that a real object exists, and can avoid colliding with or contacting the real object.

### Second Embodiment

The second embodiment describes a situation in which there is a plurality of observers wearing HMDs (HMD 400, HMD 401). Specifically, the case is assumed where the observer wearing the HMD 400 is approached by the observer wearing the HMD 401 who is positioned on the opposite side of a virtual object 408.

Device Configuration

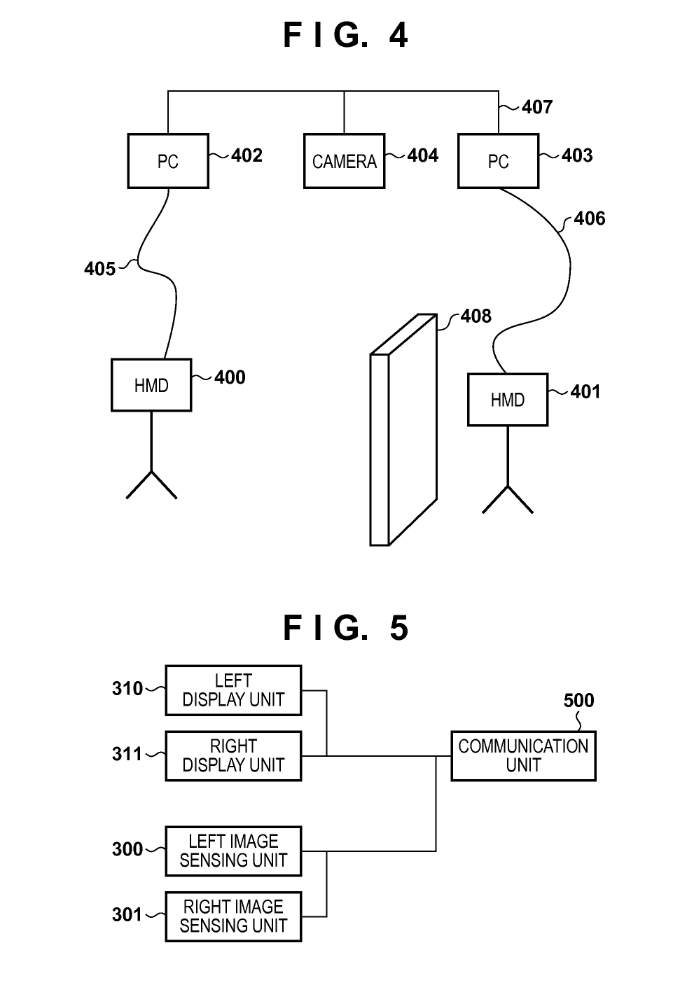

FIG. 4 is a diagram showing the overall configuration of a MR system according to the second embodiment. Here, the functional blocks of the HMD 100 are divided up and install in the HMD 400 and a PC 402, and the HMD 400 and the PC 402 are connected by a cable 405. Furthermore, a camera 404 that is able to monitor the positions of a plurality of HMDs is installed externally. This camera 404 is connected to the PC 402 and a PC 403 by a cable 407 via a network. This connection configuration may be a cable or may be wireless communication.

FIG. 5 is a diagram showing an internal configuration of the HMD 400. Because the left image sensing unit 300, the right image sensing unit 301, the left display unit 310 and the right display unit 311 are the same as the first embodiment, description is omitted. These units are connected to the external PC 402 via a communication unit 500. The connection configuration is assumed to be means similar to the cable 405. This connection configuration may, however, be wireless communication, and is not prescribed.

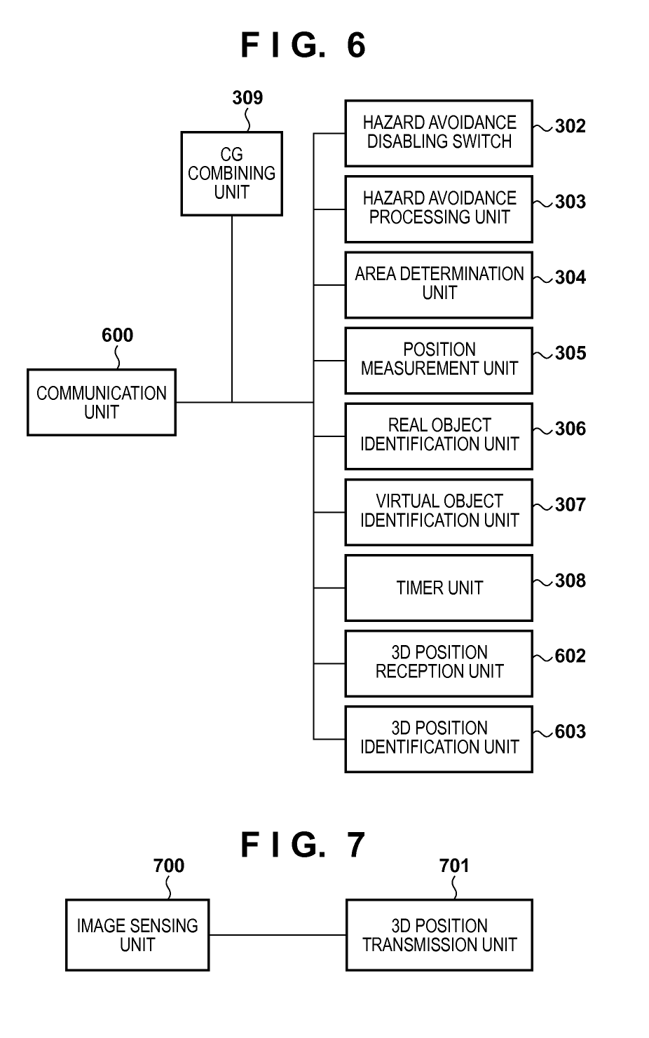

FIG. 6 is a diagram showing an internal configuration of the PC 402. Since the hazard avoidance disabling switch 302, the hazard avoidance processing unit 303, the area determination unit 304, the position measurement unit 305, the real object identification unit 306, the virtual object identification unit 307, the timer unit 308 and the CG combining unit 309 are functional units similar to the first embodiment, description is omitted. These functional units are connected to the HMD 400 through a communication unit 600.

A three-dimensional (3D) position reception unit 602 is a functional block that receives geographical position information of each HMD from the camera 404. A three-dimensional (3D) position identification unit 603 identifies the position of another HMD (here, HMD 401) that enters the visual field from the viewpoint position and direction of the HMD 400.

FIG. 7 is a diagram showing an internal configuration of the camera 404. An image sensing unit 700 captures HMDs (here, HMD 400 and HMD 401) that exist in real space, and acquires the 3D position of each HMD. The method of acquiring 3D positions may be any method that is able to identify 3D positions, such as a method of acquiring positions using infrared and a method of acquiring positions through image processing. The 3D position information obtained here is transmitted to each PC (here, PC 402 and PC 403) by a three-dimensional (3D) position transmission unit 701.

Note that the HMD 400, the PC 402 and the camera 404 are all provided with a hardware configuration including at least one CPU and various memories (ROM, RAM, etc.) which are not shown. The respective functional units 302 to 309, 602 and 603 in FIG. 6 may be provided by hardware or may be provided by software. In the case where some or all of these functional units are provided by software, the respective functions are executed by the CPU provided in the PC 402 executing software equivalent to the respective functional units.

Device Operations

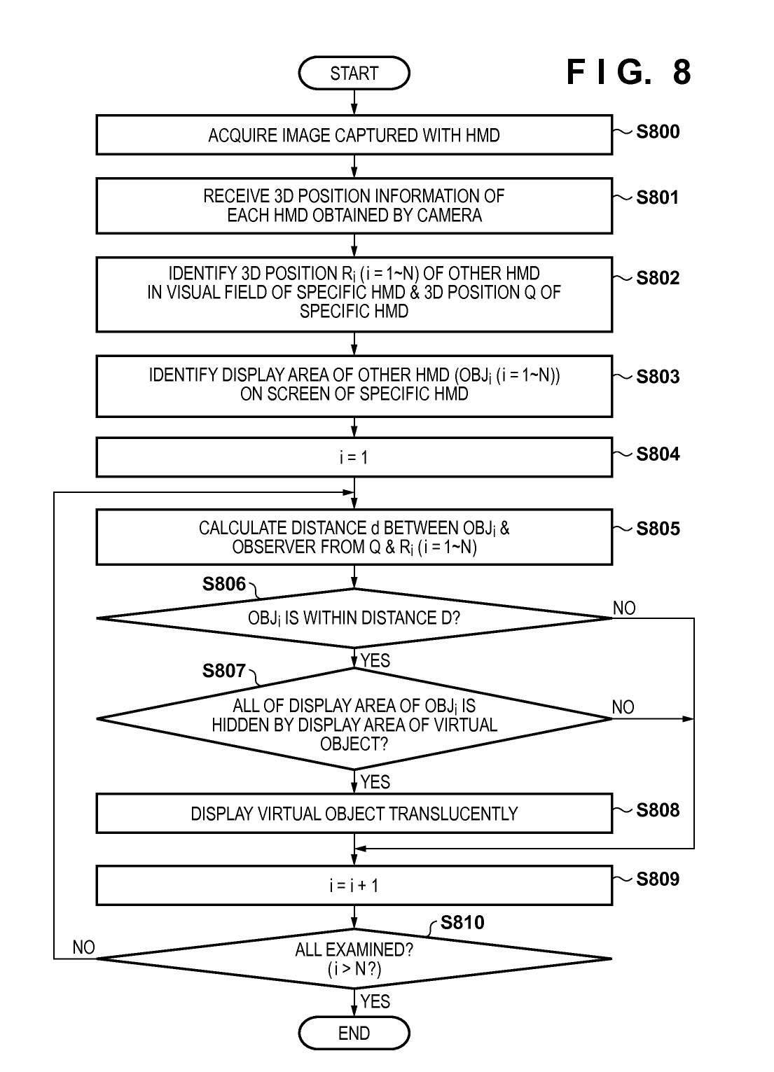

FIG. 8 is a flowchart illustrating operations of the PC 402. The steps shown in FIG. 8 are processed by the CPU provided in the PC 402 executing a program stored in memory. First, in S800, the PC 402 acquires an image captured with the image sensing unit of the HMD 400 using the communication unit 600. In S801, the PC 402 acquires the 3D position information of the HMD 400 and the HMD 401 sent from the camera 404 with the 3D position reception unit 602.

In S802, the PC 402 identifies, from the information acquired at S801, 3D position information R₁ of the HMD 401 that is in the visual field of the HMD 400 and 3D position information Q of the HMD 400 with the 3D position identification unit 603.

In S803, the PC 402 identifies “a display area OBJ₁ of the wearer of the HMD 401” on the screen of the HMD 400, based on the 3D position information R₁. The identification method given here may take an area corresponding to a peripheral portion of the HMD 401 as the display area OBJ₁, or may take an area adjacent to the HMD 401 appearing in the image from image processing as the display area OBJ₁.

In S804, the PC 402 initializes the variable i to 1. That is, the following processing of S805 to S808 is performed for each object identified at S803.

In S805, the position measurement unit 305 calculates the distance d from Q and R₁. Since the subsequent flow is similar to the first embodiment, description is omitted.

According to the second embodiment as described above, hazard avoidance processing is executed in the case where there is another HMD user who is hidden by a virtual object, and the distance d to the other HMD user is less than a predetermined distance D. As a result of this processing, a HMD user (observer) can perceive beforehand that another HMD user exists, and can avoid colliding with or contacting the other HMD user.

### Third Embodiment

The third embodiment considers a situation in which the functional blocks are divided up and installed in a HMD 900 and a PC 902, similarly to the second embodiment, and the HMD 900 and the PC 902 are connected via a wireless access point 903 (hereinafter, access point is abbreviated to AP). Hereinafter, implementation of hazard avoidance processing in the case where the state of wireless radio waves is likely to result in roaming/hand-over from the AP 903 to an AP 904 (case where the strength of received radio waves in the current wireless connection is weak) will be described.

Device Configuration

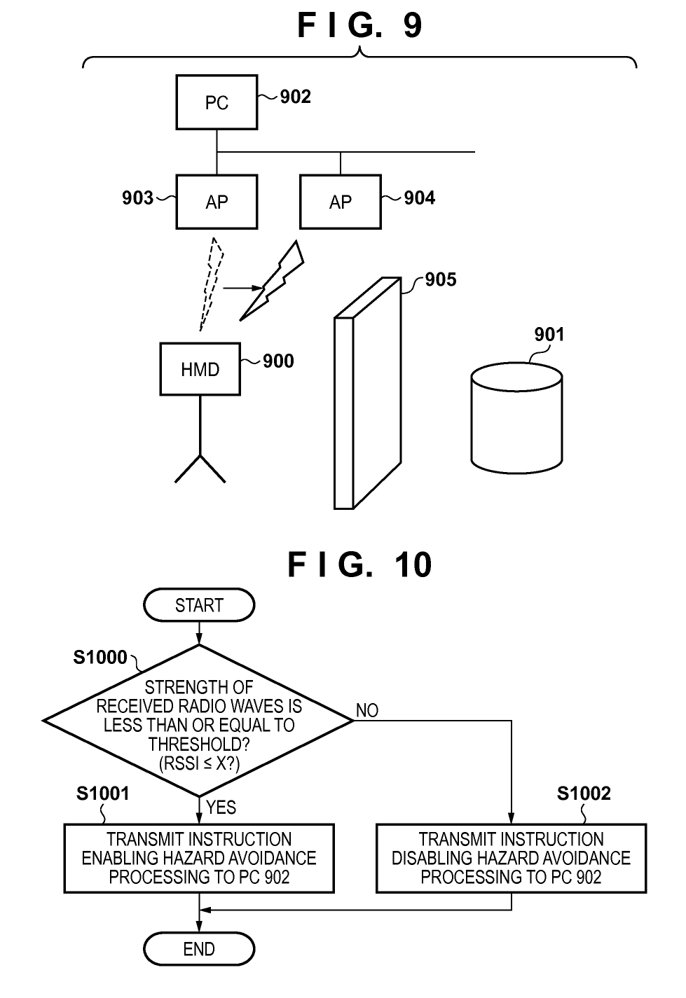

FIG. 9 is a diagram showing the overall configuration of a MR system according to the third embodiment. As described above, the functional blocks in FIG. 3 are divided up and installed in the HMD 900 and the PC 902. Also, the HMD 900 and the PC 902 are connected via the AP 903.

FIG. 12 is a diagram showing an internal configuration of the HMD 900. Since the left image sensing unit 300, the right image sensing unit 301, the left display unit 310 and the right display unit 311 are similar to the first embodiment, description is omitted. These functional units are connected to the PC 402 via a wireless unit 1200 and an AP (AP 903 or AP 904). A wireless quality measurement unit 1201 is a functional unit that monitors the strength of received radio waves (communication quality) in wireless communication, and transmits an instruction for hazard avoidance processing that is based on the monitoring result to the PC 902. Here, the wireless quality measurement unit 1201 will be described as being configured to transmit one of an instruction to enable hazard avoidance processing and an instruction to disable hazard avoidance processing.

The HMD 900 is provided with a hardware configuration including at least one CPU and various memories (ROM, RAM, etc.) that are not shown. The functional unit 1201 may be provided by hardware or may be provided by software. In the case where this functional unit is provided by software, functions are executed by the CPU provided in the HMD 900 executing software equivalent to the functional unit. Since the configuration of the PC 902 is the same as the configuration of the PC 402 of the second embodiment, description is omitted.

Device Operations

FIG. 10 is a flowchart illustrating operations of the HMD 900. The steps shown in FIG. 8 are processed by the CPU provided in the HMD 900 executing a program stored in memory. In S1000, the wireless quality measurement unit 1201 determines whether a strength RSSI of received radio waves in the current wireless connection is less than or equal to a threshold X (less than or equal to a predetermined communication quality). If the strength RSSI is less than or equal to the threshold (strength of radio waves is weak), the processing advances to S1001, and an instruction enabling the hazard avoidance processing is transmitted to the PC 902. If the strength RSSI is greater than the threshold, the processing advances to S1002, and an instruction disabling the hazard avoidance processing is transmitted to the PC 902.

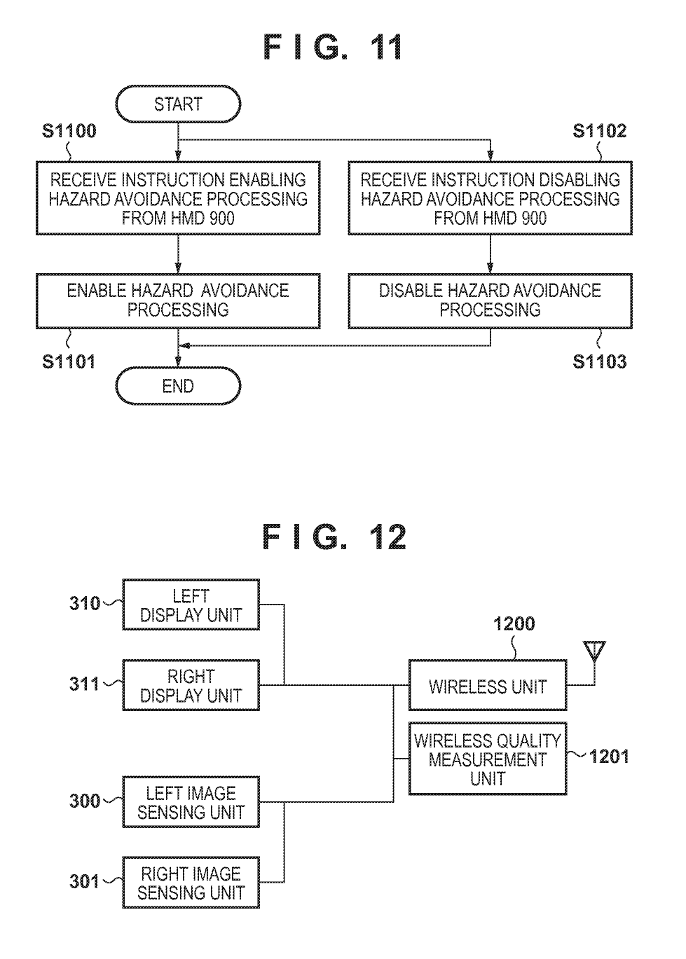

FIG. 11 is a flowchart illustrating operations of the PC 902. The PC 902, in the case where an instruction enabling the hazard avoidance processing is received from the HMD 900 (S1100), enables the hazard avoidance processing in S1101. On the other hand, the PC 902, in the case where an instruction disabling the hazard avoidance processing is received from the HMD 900 (S1102), disables the hazard avoidance processing in S1103. Since the other operations are similar to the first embodiment, description is omitted.

According to the third embodiment as described above, the HMD 900 implements hazard avoidance processing in the case where the state of wireless radio waves is likely to result in roaming/hand-over from the AP 903 to the AP 904. As a result of this processing, the fact that there is an impending danger of a collision can be presented before communication with the PC 902 is disconnected and the observer becomes unable to grasp the surrounding situation. At the same time, a situation where the sense of mixed reality is lost due to hazard avoidance processing can be minimized.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-125757, filed Jun. 18, 2014, which is hereby incorporated by reference herein in its entirety.

What is claimed is:

1. An image processing system including an image processing apparatus that is wearable by a user and is configured to capture real space and display real space video, the system comprising:
a generation unit configured to generate mixed reality video obtained by superimposing virtual object video on the real space video;
an identification unit configured to identify a display area of a real object that is included in the real space video;
a measurement unit configured to measure a distance between the image processing apparatus and the real object; and
a notification unit configured to perform notification for causing a user who is wearing the image processing apparatus to recognize existence of the real object, if the display area of the real object is hidden by the virtual object video, and the distance between the image processing apparatus and the real object is less than a predetermined distance.

2. The image processing system according to claim 1, wherein the notification unit performs the notification, if all of the display area of the real object is hidden by the virtual object video, and the distance between the image processing apparatus and the real object is less than the predetermined distance.

3. The image processing system according to claim 1, wherein the notification unit causes the image processing apparatus to display a warning indicating that the real object exists, or sets the virtual object video to be displayed translucently or as a contour.

4. The image processing system according to claim 1, further comprising a velocity determination unit configured to determine a relative velocity of the real object relative to the image processing apparatus, based on a temporal change in the distance measured by the measurement unit,
wherein the notification unit performs the notification, if the display area of the real object is hidden by the virtual object video, the distance between the image processing apparatus and the real object is less than the predetermined distance, and the relative velocity determined by the velocity determination unit is greater than or equal to a predetermined velocity.

5. The image processing system according to claim 1, wherein the measurement unit is a depth sensor.

6. The image processing system according to claim 1, further comprising an image sensing unit for a left eye and an image sensing unit for a right eye,
wherein the measurement unit computes the distance based on a parallax between an image obtained by the image sensing unit for the left eye and an image obtained by the image sensing unit for the right eye.

7. The image processing system according to claim 1, wherein the measurement unit computes the distance based on a geographical position of the image processing apparatus and a geographical position of the real object that are acquired from an external apparatus.

8. The image processing system according to claim 1, further comprising a disable setting unit for disabling the notification by the notification unit.

9. A method for controlling an image processing system including an image processing apparatus that is wearable by a user and is configured to capture real space and display real space video, the method comprising:
generating mixed reality video obtained by superimposing virtual object video on the real space video;
identifying a display area of a real object that is included in the real space video;
measuring a distance between the image processing apparatus and the real object; and
performing notification for causing a user who is wearing the image processing apparatus to recognize existence of the real object, if the display area of the real object is hidden by the virtual object video, and the distance between the image processing apparatus and the real object is less than a predetermined distance.

10. An image processing system including an image processing apparatus that is wearable by a user and is configured to capture real space and display real space video, the system comprising:
a generation unit configured to generate mixed reality video obtained by superimposing virtual object video on the real space video;
an identification unit configured to identify a display area of a real object that is included in the real space video;
a measurement unit configured to measure a distance between an identified real object that is moving and a user who is wearing the image processing apparatus; and
a notification unit configured to perform notification for causing the user who is wearing the image processing apparatus to recognize existence of the real object that is moving, if the display area of the real object that is moving is hidden by the virtual object video, and the distance measured by the measurement unit is less than a predetermined distance.

11. The image processing system according to claim 10, wherein the notification unit performs the notification, if all of the display area of the real object that is moving is hidden by the virtual object video, and the distance measured by the measurement unit is less than the predetermined distance.

12. The image processing system according to claim 10, wherein the notification unit causes the image processing apparatus to display a warning indicating that the real object exists, or sets the virtual object video to be displayed translucently or as a contour.

13. The image processing system according to claim 10, further comprising a velocity determination unit configured to determine a relative velocity of the real object relative to the user, based on a temporal change in the distance measured by the measurement unit,
wherein the notification unit performs the notification, if the display area of the real object that is moving is hidden by the virtual object video, the distance measured by the measurement unit is less than the predetermined distance, and the relative velocity determined by the velocity determination unit is greater than or equal to a predetermined velocity.

14. The image processing system according to claim 10, wherein the measurement unit is a depth sensor.

15. The image processing system according to claim 10, further comprising an image sensing unit for a left eye and an image sensing unit for a right eye,
wherein the measurement unit computes the distance based on a parallax between an image obtained by the image sensing unit for the left eye and an image obtained by the image sensing unit for the right eye.

16. The image processing system according to claim 10, wherein the measurement unit computes the distance based on a geographical position of the image processing apparatus and a geographical position of the real object that are acquired from an external apparatus.

17. The image processing system according to claim 10, further comprising a disable setting unit for disabling the notification by the notification unit.

18. A method for controlling an image processing system including an image processing apparatus that is wearable by a user and is configured to capture real space and display real space video, the method comprising:
generating mixed reality video obtained by superimposing virtual object video on the real space video;
identifying a display area of a real object that is included in the real space video;
measuring a distance between an identified real object that is moving and a user who is wearing the image processing apparatus; and
performing notification for causing the user who is wearing the image processing apparatus to recognize existence of the real object that is moving, if the display area of the real object that is moving is hidden by the virtual object video, and the measured distance is less than a predetermined distance.
